(19) United States
(12) Patent Application Publication
(10) Pub. No.: US 2005/0093667 A1
(43) Pub. Date: May 5, 2005

(54) Three-dimensional inductive micro components

(76) Inventors: Arnd Kilian, Berlin (DE); Ralf Hauffe, Berlin (DE)

Correspondence Address: FISH & RICHARDSON P.C., CITIGROUP CENTER 52ND FLOOR, 153 EAST 53RD STREET, NEW YORK, NY, 10022-4611, US

(21) Appl. No.: 10/699,981

(22) Filed: Nov. 3, 2003

(51) Int. Cl. H01F 5/00

(52) U.S. Cl. 336/200

(57) ABSTRACT

Techniques and structures for three-dimensional inductive micro components are disclosed. The inductive micro components may be used, for example, in micro circuits and may be integrated with other components hermetically sealed in a micro housing. In some implementations, the inductive micro component may be tunable.

### BACKGROUND

The present disclosure relates to three-dimensional inductive micro components such as micro inductors or micro transformers.

Electrical coils are often used as inductors and transformers in electrical circuit design. Generally, the inductance value of a given structure is a function of its length and the number of windings or coils. In integrated circuits, the coils may be planar, i.e., existing in two dimensions only. Recently, three-dimensional micro-coil devices have been proposed. The present disclosure relates to such three-dimensional inductive micro components.

### SUMMARY

An inductive micro component, which may comprise, for example, conductive windings in the shape of a coil, may be fabricated in various ways according to the invention.

One disclosed method includes providing trenches in a substrate to define a continuous, unbroken core in the substrate for an inductive component and providing conductive material around the continuous, unbroken core to define windings for the inductive component.

Alternative methods include forming conductive lines each of which extends along a bottom surface of a trench in a substrate, along opposing sidewalls of the trench, and along an upper surface of the substrate on both sides of the trench. Conductive interconnections are provided among portions of the conductive lines to form windings for an inductive component where the windings are composed of the conductive lines and the conductive interconnections. In one embodiment, a wire bonding technique is used to provide the conductive interconnections. In another embodiment, the conductive interconnections are provided by positioning a cover over the substrate. The cover includes the conductive interconnections to interconnect the conductive lines to form the windings for the inductive component. Such techniques can simplify the fabrication process and can more easily allow the inductive micro component to be integrated on the same substrate with other components.

Preferably, the conductive interconnections interconnect a portion of a first conductive line to a portion of a second adjacent conductive line, where the portion of the first conductive line is located along the upper surface of the substrate on a first side of the trench and the portion of the second conductive line is located along the upper surface of the substrate on a second, opposite side of the trench. Together the interconnections and conductive lines form the inductive windings.

In some implementations, the core may be an air core. In other implementations, a magnetic material may be provided in the trench to serve as a core for the inductive component. In some cases, the trench may be used to help position the magnetic core material, which may be fixed in place using an adhesive or other suitable material.

Various implementations are disclosed in which the inductive micro component is tunable.

Inductive components fabricated according to the foregoing techniques may be integrated into electronic microcircuits that may include additional electronic or opto-electronic components.

One or more of the following advantages may be present in some implementations. Fabricating the inductive component on the substrate may allow for the integration of resistors lowering the Q-factor of the coil. Also, capacitors may be added to build more complex electronic filters. The resistors and capacitors may be deposited on the substrate, for example, by thin film deposition techniques.

Furthermore, the inductive micro component can be hermetically encapsulated by providing a solder ring along the edge of the two substrates. Electrical contacts can be provided to the inductive micro component through additional electrical lines on the substrate surface connecting to the ends of the coil winding. These additional electrical lines can be fed hermetically through the substrate wall if desired.

The inductive micro component may be integrated with other electronic and opto-electronic components into a micro housing for an opto-electronic transmitter module.

Other features and advantages will be readily apparent from the following detailed description, the accompanying drawings and the claims.

### BRIEF DESCRIPTION OF THE DRAWINGS

FIG. 1 illustrates a first embodiment of an inductive micro component according to the invention.

FIG. 2 illustrates the underside of the micro component of FIG. 1

FIG. 3 illustrates a second embodiment of an inductive micro component according to the invention.

FIG. 4 illustrates a third embodiment of an inductive micro component according to the invention.

FIG. 5 illustrates an example of a tunable inductive micro component according to the invention.

FIG. 6 illustrates the underside of the micro component of FIG. 5.

FIG. 7 illustrates another example of a tunable inductive micro component according to the invention.

FIG. 8 illustrates an inductive micro component integrated into a hermetic micro housing with other electronic and opto-electronic components.

### DETAILED DESCRIPTION

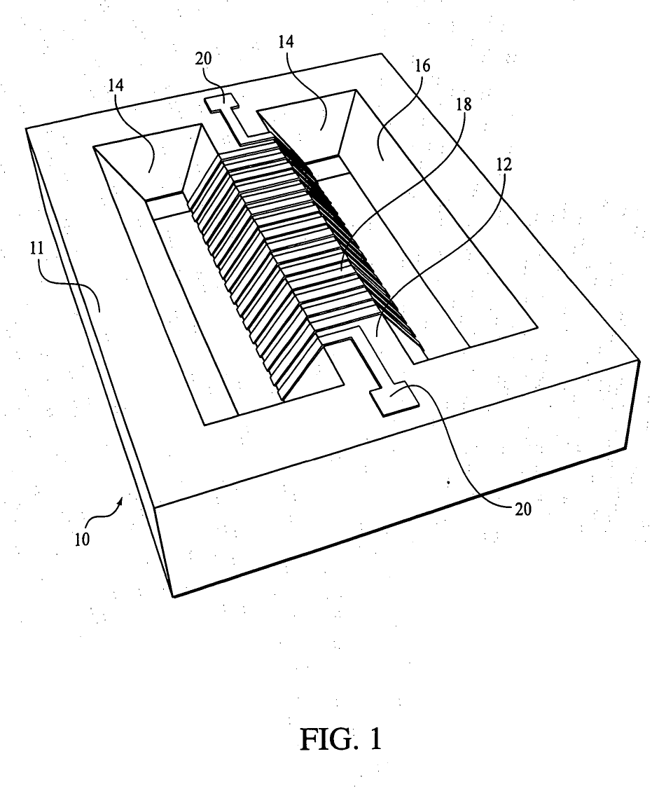

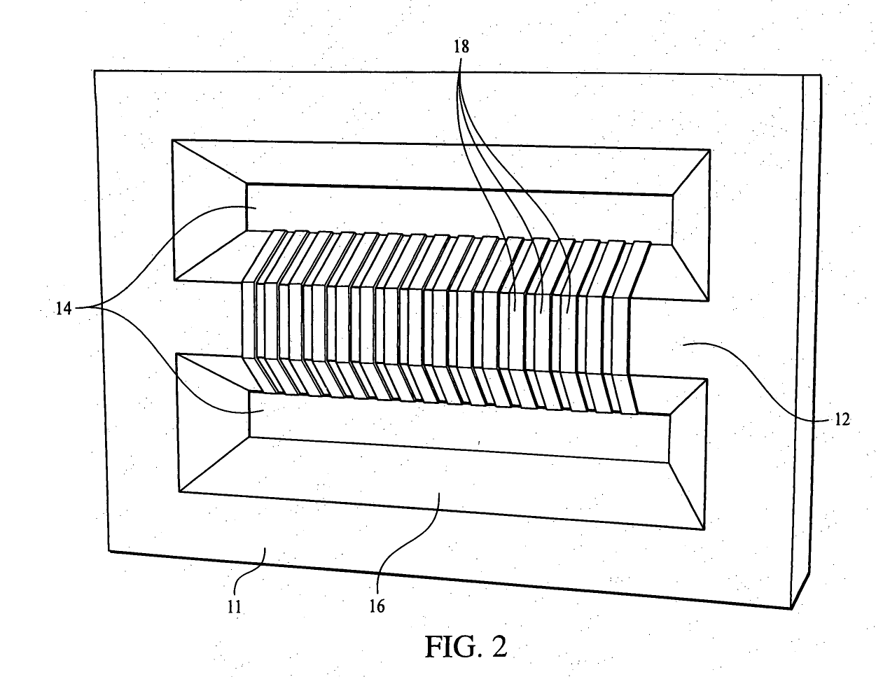

As shown in FIGS. 1 and 2, an inductive micro component 10 may be formed on a silicon or another substrate 11, with a portion of the substrate serving as a continuous, unbroken inductor core 12. The core may be defined by forming a pair of substantially parallel trenches 14 in the substrate. If the substrate is silicon, wet etching may be used, for example, to form the trenches 14. The trenches may be etched from one side or from both sides of the substrate to provide symmetrically slanted sidewalls 16. If the substrate is composed of another material, such as glass, then other techniques such as sandblasting may be used to form the trenches.

After the trenches are formed to define the core 12, conductive (e.g., metal) lines 18 are deposited about the core to form the inductor windings. Conventional thin-film electro-deposition and patterning techniques may be used to deposit the metal lines 18 about the core. As illustrated in FIGS. 1 and 2, the metal lines extend along the sides of the trenches 14 adjacent the core 12, as well as along the top and bottom of the core. The number of windings and the distance between adjacent windings depends on the particular application. Conductive pads 20 for providing electrical connections to the inductive micro component may be formed at the same time as the inductor windings. Although the pads 20 are shown on the top surface of the substrate, in other implementations they may be provided on the opposite (bottom) surface. The inductive micro component may be surface mountable.

In some implementations, the trenches 14 are etched all the way through the substrate 12, thus resulting in through-holes. In other implementations, however, the trenches can terminate at a membrane, and hermetic feed-throughs through the membrane may be provided at each of the electrical lines.

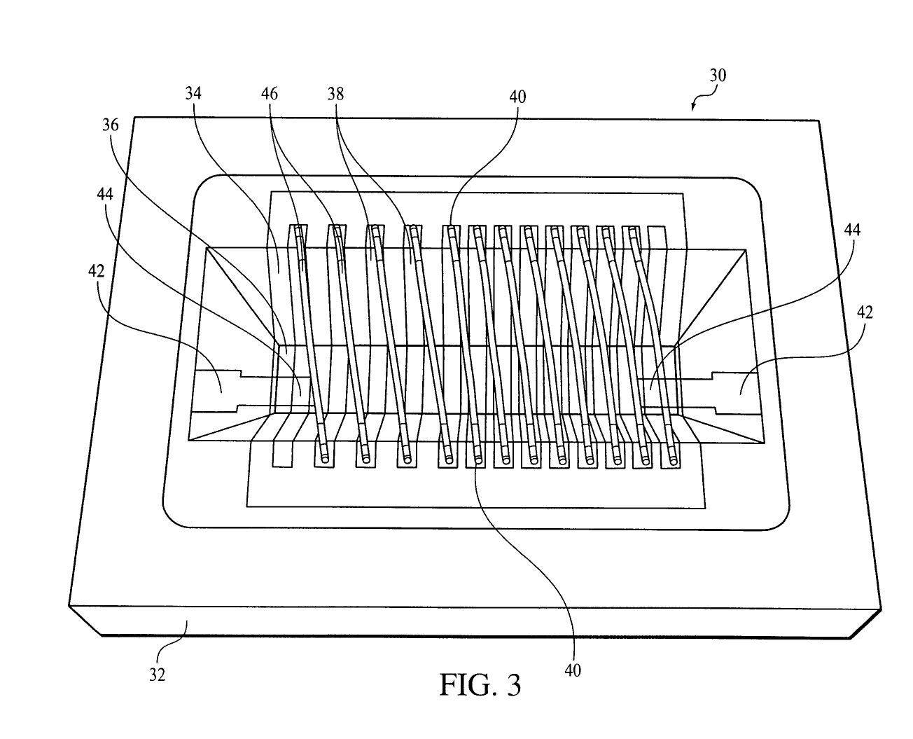

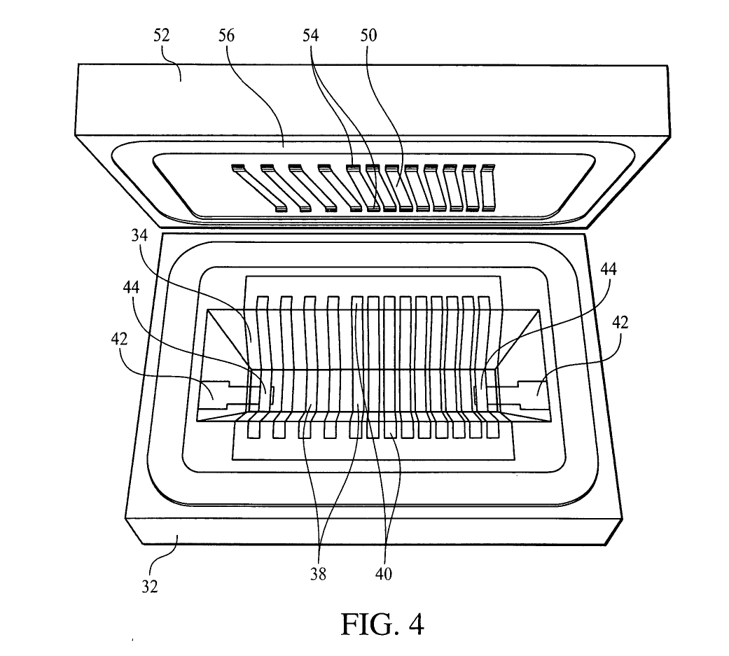

FIGS. 3 and 4 illustrate inductive components in which conductive (e.g., metal) lines are provided in a trench and conductive interconnections are provided among portions of the metal lines that extend outside the trench onto the surface of the substrate to define the windings of the inductive component. The windings are composed of the metal lines and the conductive interconnections. In contrast to the embodiment of FIGS. 1 and 2, the inductive components of FIGS. 3 and 4 may have an air-core. Although a magnetic core may be provided in some implementations, the interconnections do not require a separate underlying layer for mechanical support (other than where they contact the metal lines).

For example, FIG. 3 illustrates an inductive micro component 30. In this case, a trench 34 may be formed in the substrate 32, for example, by wet etching or another suitable technique. The substrate may be composed of silicon or another material, such as glass. The trench, which may include slanted sidewalls, is not etched all the way through the substrate, but instead has a bottom surface 36. Metal lines 38 that form part of the inductor windings are deposited along the sides and bottom of the trench. Portions 40 of each metal line 38 also extend outside the trench onto the substrate surface on either side of the trench. The metal lines 38 may be substantially parallel to one another and may have substantially uniform width and spacing. They may be formed by conventional thin-film or electro-deposition and patterning techniques. Connection pads 42 may be provided on the underside of the substrate with feed-throughs 44 electrically connecting the metal lines to the pads. Alternatively, the contact pads 42 may be located on the top surface of the substrate, in which case feed-throughs 44 can be omitted.

Next, conductive wires 46 are connected to the ends of the metal lines to complete the inductor windings. Wire bonding techniques may be used to provide the conductive wires 46. Examples of such techniques include die bonding, thermo-compression bonding and ultrasonic bonding. Each interconnecting wire electrically couples a portion 40 of a metal line 38 located on the substrate surface at one side of the trench to the portion 40 of an adjacent metal line located on the substrate surface at the other side of the trench. Thus, the metal lines 38 and interconnecting wires 46 form the inductor windings. The number of windings may depend on the particular application.

The space enclosed by the windings may be left empty to form an “air core.” Alternatively, the space may be filled with a magnetic material to form a magnetic core and increase the inductance. For implementations with a magnetic core, the material for the magnetic core may be positioned in the trench prior to formation of the interconnecting wires 46. The trench 34 may be used to position the core material in the space surrounded by the inductor windings. The core may be composed of a solid, such as a bar of magnetic material. Alternatively, the trench may be filled with magnetic particles suspended in a liquid which subsequently is hardened (e.g., by polymerization or evaporation). Further adaptations of the properties of the inductance can be achieved by changing the distance of the wires or by tapering the trench. A lid (not shown in FIG. 3) may be placed over the substrate to provide a hermetic seal and to protect the inductive micro component.

Instead of using wire bonding as in FIG. 3, metal lines formed in the trench may be connected electrically by a second group of conductive (e.g., metal) lines 50 formed on a lid 52 that is placed over the substrate as shown, for example, in FIG. 4. Similar features in the embodiments of FIGS. 3 and 4 are identified by the same reference numerals. The second group of metal lines 50 on the lid may be formed, for example, by conventional thin-film or electro-deposition and patterning techniques and serve as conductive interconnections among the first group of metal lines. When the lid 52 is properly positioned over the substrate, each metal line 50 on the lid electrically couples a portion 40 of a metal line 38 located on the substrate surface at one side of the trench 34 to a portion 40 of an adjacent metal line 38 located on the substrate surface at the other side of the trench to form the inductor windings. Solder bumps 54 may be provided at either end of the metal lines 50 for contact with the first group of metal lines 38.

As in the embodiment of FIG. 3, the inductor core may be an air-core. Alternatively, prior to positioning the lid 52, a magnetic core material may be positioned in the trench.

In some implementations, the lid 50 may be hermetically sealed to the substrate 32, for example, through the use of a solder ring 56. Thus, the inductive micro component can be hermetically encapsulated by providing a solder ring along the edge of the two substrates. Electrical contacts may be provided to the inductive micro component through additional electrical lines on the substrate surface connecting to the ends of the coil winding. The additional electrical lines may be fed hermetically through the substrate wall if desired.

An electronic package may include a substrate with a single inductive component as described above or the package may include additional electronic or opto-electronic components mounted to or formed in the same substrate.

Forming an inductive component on a substrate as described above may ease assembly on electronic circuit boards while simultaneously allowing the integration of other passive (e.g., resistor, capacitors) or active (e.g., electronic or opto-electronic) components on the same substrate. The inductive component may be used in electronic microcircuits, for example, as an inductor or transformer, or in laser driving circuits as a bias-tee.

In some implementations, it may desirable to provide a tunable inductive micro component to allow the inductance of the micro component to be changed depending on the application. In various implementations, the inductive component may be continuously tunable or it may be tunable over a fixed number of discrete values.

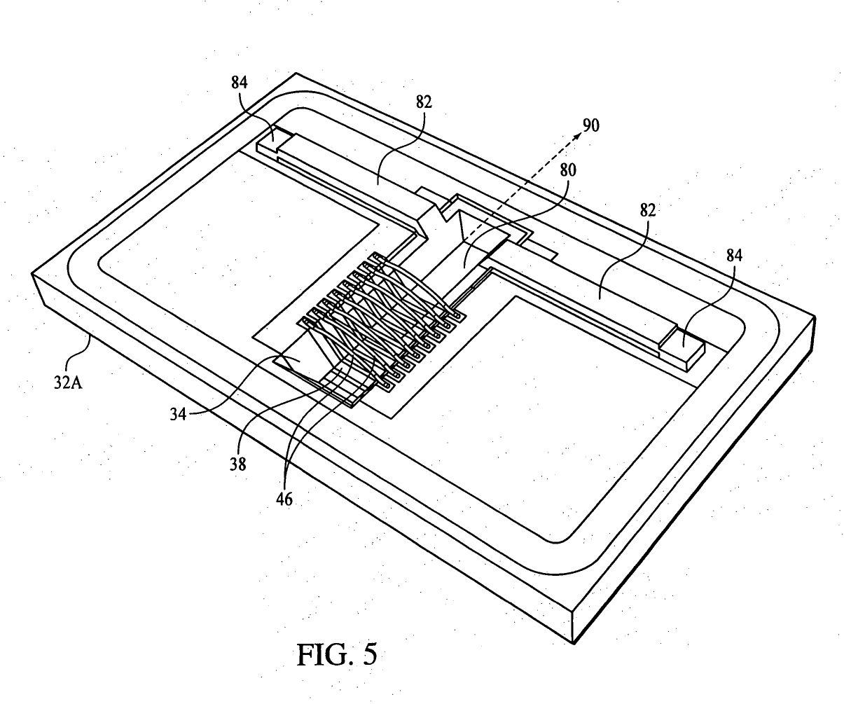

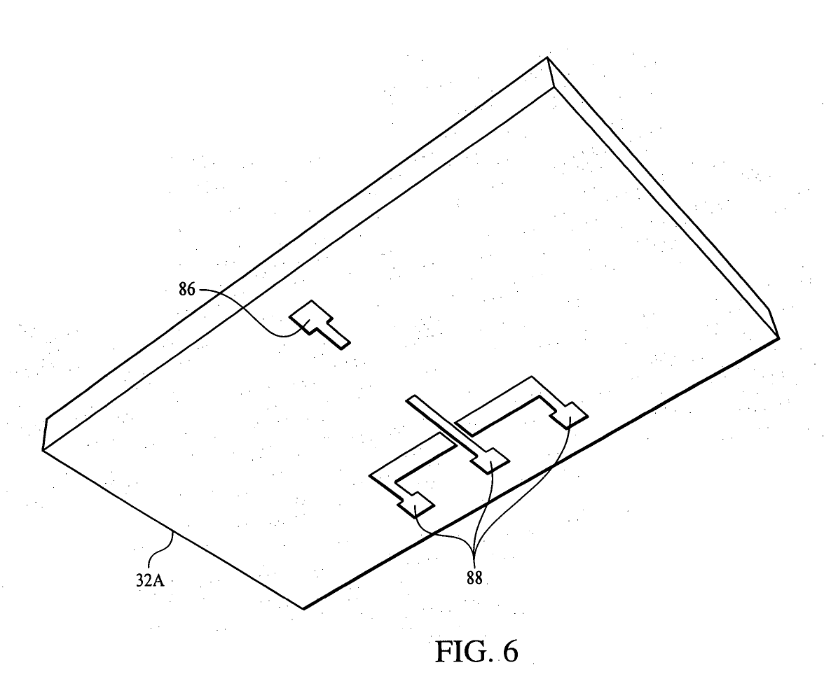

FIGS. 5 and 6, for example, illustrate an example of a continuously tunable inductive micro component 30A formed in a substrate 32A. Like the inductive micro component 30 of FIG. 3, the inductive micro component 30A includes metal or other conductive lines 38 formed along the bottom of a trench 34. Conductive wires 46 connect the metal lines 38 as described in connection with FIG. 3 to complete the inductor windings.

The inductive component 30A also includes a core 80 that is suspended in the trench 34 between the inductor windings. Attached to the core 80 are flexible arms 82 that are suspended slightly above the surface of the substrate and that extend in a direction substantially perpendicular to the axial direction of the inductive component. The arms 82 are connected at their distal ends to the substrate 32A through hinges 84. The core 80, the flexible arms 82 and the hinges 84 may comprise the same material, such as nickel or other suitable metal. Preferably, they comprise a magnetic material. Depending on the voltages applied to contact pads 86, 88 that are coupled to the inductor windings, the core 80 can be moved slightly in or out of the area encircled by the inductor windings to tune the inductance. In one implementation, a direct current (DC) bias may be applied to cause the arms 82 to expand slightly, thereby pushing the core 80 slightly in the axial direction (i.e., the direction of arrow 90). When the DC bias is removed, the arms 82 retract, thereby acting as a spring to move the core slightly in a direction out of the area defined by the inductor windings. The arms 82 also may help guide the core so that any movement is primarily in the axial direction. Although only one pair of arms 82 is illustrated in FIG. 5, a second pair of arms may be provided to improve the guiding capability.

The tunable inductive component 30A may be fabricated as follows. The groove 34, metal lines 38 and any feedthroughs may be formed as described above. Next, a sacrificial metal layer is deposited over the entire surface of the substrate. A sacrificial copper layer of about ten microns (μm) may be suitable for some implementations. Windows are opened in the sacrificial layer to areas for the hinges 84. Photoresist is then deposited and patterned to define the structure of the layer forming the core 80, as well as the arms 82 and hinges 84. Next, the material for the core layer is deposited, for example, by electroplating. The sacrificial layer is then etched away, resulting is the suspended core 80, arms 82 and hinges 84. If copper is used for the sacrificial layer, ammonium (NH₄OH) may be used, for example, as the etchant. The wire bonds 46 may then be added to complete the conductor windings.

In an alternative implementation, photoresist may be used for the sacrificial layer. After patterning the photoresist, a plating base is deposited for the electrode position of the core material. Another photoresist layer may then be deposited and patterned to define the structure for the core layer. The remaining layers and features may be processed as discussed above.

In some implementations, other techniques may be used to tune the indictor instead of applying a DC bias voltage to the inductor windings. For example, an additional coil at one end of the core may be provided for that purpose or an additional micro-electromechanical system (MEMS) structure on the substrate 32A may serve as an actuator.

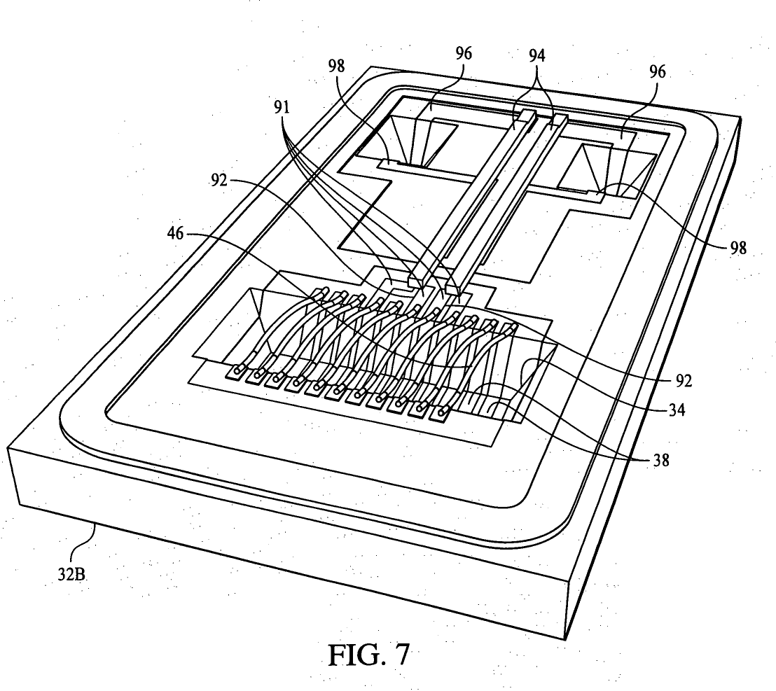

FIG. 7 illustrates an example of an inductive micro component 30B that is tunable over a discrete number of fixed values 30A. Thus, tuning the inductance value can include changing the inductance from a first value to a second value without passing through a range of continuous values between the first and second values.

Like the inductive component 30 of FIG. 3, the inductive component 30B includes metal or other conductive lines 38 formed along the bottom of a trench 34. Conductive wires 46 connect the metal lines 38 as described in connection with FIG. 3 to complete the inductor windings. In addition, as shown in FIG. 7, one or more pairs of conductive lines 38 include conductive contact areas 90 with a small gap 92 between them. Suspended cantilever arms 94, which may be formed as MEMS structures, act as switches that can be set in open or closed positions. The switches may be closed, for example, by applying appropriate voltages to the contacts 96, 98. The contact 96 is connected to the far end of the cantilever arm 94, whereas the other contact 98 acts as an electrode extending beneath the arm. When an appropriate electric field is applied, the electrostatic force causes the cantilevered arm 94 to move downward so as to close the gap 92 and provide a short circuit between the contacts 90 and, therefore, between the associated inductor windings. The inductance of the micro component 34B can, therefore, be tuned by opening or closing one or more of the switches 94. Although two such switches are shown in FIG. 7, other implementations may include one or more switches.

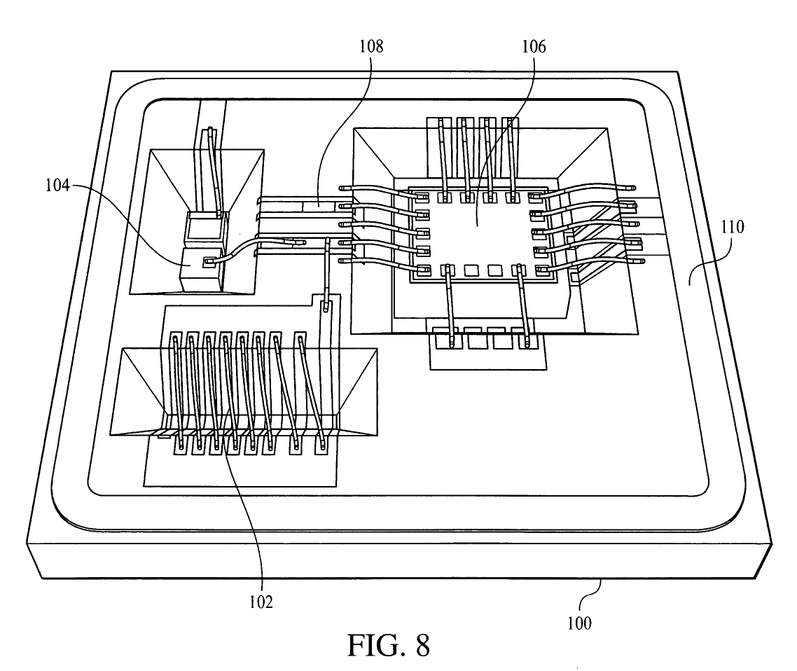

The inductive micro components described above may be incorporated into a hermetically sealed package. For example, FIG. 8 illustrates a substrate 100 that includes an inductive micro component 102, similar to the one discussed above in connection with FIG. 3. The micro component 102 is integrated as part of a hermetically sealed package with a semiconductor laser 104 and laser driver chip 106. The substrate also may include passive components such as thin film resistors 108 formed on the same substrate as the other components. A lid (not shown) may be hermetically sealed to the substrate using, for example, a solder ring 110.

Other implementations are within the scope of the claims.

1. A method comprising:
providing trenches in a substrate to define a continuous, unbroken core in the substrate for an inductive component; and
providing a conductive material around the continuous, unbroken core to define a plurality of windings for the inductive component.

2. The method of claim 1 wherein the substrate comprises silicon.

3. The method of claim 2 wherein providing the trenches includes etching the substrate.

4. The method of claim 3 including etching the substrate to form trenches with slanted sidewalls.

5. The method of claim 1 wherein the conductive material for the windings is provided along sidewalls of the trenches adjacent the core and along top and bottom surfaces of the core.

6. The method of claim 1 wherein providing trenches in the substrate includes forming through-holes through the substrate.

7. The method of claim 1 wherein providing trenches includes etching from opposite sides of the substrate.

8. An electronic microcircuit comprising:
a substrate including trenches that define a continuous, unbroken portion of the substrate to serve as a core of an inductive component; and
conductive material around the continuous, unbroken portion defining a plurality of windings for the inductive component.

9. The electronic microcircuit of claim 8 wherein the trenches extend through the substrate on either side of the core.

10. The electronic microcircuit of claim 8 wherein the substrate comprises silicon.

11. The electronic microcircuit of claim 8 including conductive pads on the substrate to provide electrical connection to the windings.

12. The electronic microcircuit of claim 8 wherein the trenches are located along sides of the portion serving as the core and are substantially parallel to one another, and wherein the conductive material is provided along slanting sidewalls of the trenches and along top and bottom surfaces of the core.

13. The electronic microcircuit of claim 8 including hermetic feed-throughs extending from a trench on one side of the substrate to a trench on a second side of the substrate.

14. A method comprising:
forming a plurality of conductive lines each of which extends along a bottom surface of a trench in a substrate, along opposite sidewalls of the trench, and along an upper surface of the substrate on both sides of the trench; and
using a wire bonding technique to provide conductive interconnections among portions of the conductive lines to form a plurality of windings for an inductive component wherein the windings are composed of the conductive lines and the conductive interconnections.

15. The method of claim 14 wherein providing conductive interconnections includes, for pairs of adjacent conductive lines, coupling a wire bond from a portion of a first metal line to a portion of a second metal line, wherein the portion of the first metal line is located along the upper surface of the substrate at a first side of the trench and the portion of the second metal line is located along the upper surface of the substrate at a second, opposite side of the trench.

16. The method of claim 15 including positioning a magnetic material in the trench as a core for the inductive component.

17. The method of claim 16 including tuning an inductance value of the inductive component by adjusting a position of the core.

18. The method of claim 17 including applying an electrical signal to adjust the position of the core.

19. The method of claim 18 wherein tuning the inductance value includes passing through a range of continuous values.

20. The method of claim 17 wherein tuning the inductance value includes changing the inductance from a first value to a second value without passing through a range of continuous values between the first and second values.

21. An electronic microcircuit comprising:
a substrate;
a plurality of conductive lines each of which extends along a bottom surface of a trench in the substrate, along opposing sidewalls of the trench, and along an upper surface of the substrate at both sides of the trench; and
wire bonds interconnecting portions of the conductive lines to define a plurality of windings for an inductive component wherein the windings are composed of the conductive lines and the wire bond interconnections.

22. The electronic microcircuit of claim 21 wherein each wire bond interconnects a portion of a first conductive line to a portion of a second conductive line, wherein the portion of the first conductive line is located along the upper surface of the substrate at a first side of the trench and the portion of the second conductive line is located along the upper surface of the substrate at a second, opposite side of the trench.

23. The electronic microcircuit of claim 22 including a magnetic material in the trench as a core for the inductive component.

24. The electronic microcircuit of claim 21 wherein an inductance value of the inductive component is tunable.

25. The electronic microcircuit of claim 21 wherein the inductive component is tunable over a continuous range of values.

26. The electronic microcircuit of claim 21 wherein the inductive component is tunable from a first value to a second value without passing through a range of continuous values between the first and second values.

27. A method comprising:
forming a plurality of conductive lines each of which extends along a bottom surface of a trench in a substrate, along opposite sidewalls of the trench, and along an upper surface of the substrate at both sides of the trench; and
positioning a cover over the substrate, wherein the cover includes conductive interconnections to interconnect the conductive lines to form a plurality of windings for an inductive component, wherein the windings are composed of the conductive lines and interconnections.

28. The method of claim 27 wherein, when the cover is positioned over the substrate, each conductive interconnection interconnects a portion of a first conductive line to a portion of an adjacent second conductive line, wherein the portion of the first conductive line is located along the upper surface of the substrate at a first side of the trench and the portion of the second conductive line is located along the upper surface of the substrate at a second, opposite side of the trench.

29. The method of claim 28 including positioning a magnetic material in the trench as a core for the inductive component.

30. An electronic microcircuit comprising:
a substrate;
a plurality of conductive lines each of which extends along a bottom surface of a trench in the substrate, along opposing sidewalls of the trench, and along an upper surface of the substrate at both sides of the trench; and
a cover over the substrate, wherein the cover includes conductive interconnections to interconnect the conductive lines to form a plurality of windings for an inductive component, wherein the windings are composed of the conductive lines and interconnections.

31. The microcircuit of claim 23 wherein, when the cover is positioned over the substrate, each conductive interconnection interconnects a portion of a first conductive line to a portion of an adjacent second conductive line, wherein the portion of the first conductive line is located along the upper surface of the substrate at a first side of the trench and the portion of the second conductive line is located along the upper surface of the substrate at a second, opposite side of the trench.

32. The electronic microcircuit of claim 24 including a magnetic material in the trench as a core for the inductive component.
